(19) United States
(12) Patent Application Publication
(10) Pub. No.: US 2014/0366553 A1
(43) Pub. Date: Dec. 18, 2014

(54) COMBUSTION CHAMBER FOR A GAS TURBINE AND GAS TURBINE AND A METHOD OF USE

(71) Applicant: SIEMENS AKTIENGESELLSCHAFT, München (DE)

(72) Inventors: Christian Beck, Essen (DE); Olga Deiss, Dusseldorf (DE); Werner Krebs, Mulheim an der Ruhr (DE); Bernhard Wegner, Berlin (DE)

(73) Assignee: SIEMENS AKTIENGESELLSCHAFT, München (DE)

(21) Appl. No.: 14/363,877

(22) PCT Filed: Nov. 9, 2012
(86) PCT No.: PCT/EP2012/072222

§ 371 Date: Jun. 9, 2014

(30) Foreign Application Priority Data
Dec. 9, 2011 (EP) 11192767.9

(51) Int. Cl. F02C 7/24; F23R 3/28

(52) U.S. Cl. CPC F02C 7/24; F23R 3/286
USPC 60/779; 60/725; 60/737

(57) ABSTRACT

A combustion chamber (10, 20) for a gas turbine (1) having a housing (12, 23), a combustion zone (21, 22, 47) surrounded by the housing (12, 23), and at least one burner arrangement (11, 25), which has at least one pre-mixing passage (28) opening into the combustion zone (21, 22) for preparation of a fuel/air mixture. To enable suppression of combustion chamber pressure fluctuations, at least one interference body (50) is provided against which a flow can take place and to which a Strouhal number can be assigned, the flow generating fluidically induced sound waves. The interference body (50) is in a passage (48, 59) opening into the combustion zone (21, 22, 47). A fluid (51, 62) flowing through the passage (48, 59) in the direction of the combustion zone generates a sound wave with a frequency f by flowing against the interference body (50), wherein the frequency f substantially corresponds to a dominant frequency of the combustion chamber.

The invention relates to a combustion chamber for a gas turbine, having a housing, a combustion zone which is surrounded by the housing, and at least one burner arrangement, wherein the burner arrangement comprises at least one premixing passage which issues into the combustion zone and which serves for the provision of a fuel/air mixture.

The invention also relates to a gas turbine having a combustion chamber of the type mentioned in the introduction, and to a method for suppressing combustion chamber pressure oscillations.

Known gas turbines comprise, in addition to a combustion chamber as mentioned in the introduction, a compressor and a turbine. The compressor compresses air that is supplied to the gas turbine, wherein one part of said air serves for the combustion of fuel in the combustion chamber, and one part is used for the cooling of the gas turbine and/or of the combustion gases. The hot gases generated by the combustion process in the combustion chamber are introduced from the combustion chamber into the turbine, wherein said gases expand and cool in the turbine and, in so doing, perform work so as to set turbine blades in rotation. By means of said rotational energy, the gas turbine drives a work machine. The work machine may for example be a generator.

The fuel/air mixture provided through the at least one burner arrangement is premixed in premixing passages before then being ignited after flowing into the combustion zone. The premixing of the fuel with the air reduces the pollutant emissions generated during the combustion. The fuel is supplied via at least one fuel line to the premixing passage and is injected into the premixing passage. If pressure oscillations occur in the combustion zone, concentration fluctuations arise in the mixture, which lead to fluctuations in the release of heat during the combustion. These thermoacoustic instabilities form disruptive combustion chamber pressure oscillations, wherein dominant frequencies for said combustion chamber pressure oscillations exist in the arrangement. For this reason, known gas turbines comprise resonators arranged in the housing, which resonators serve for the suppression of combustion chamber pressure oscillations in the range of such dominant frequencies. For effective suppression, a multiplicity of such resonators is required. Since the resonators directly adjoin the combustion zone and furthermore form interruptions in a heat shield arrangement in the housing and must therefore be cooled, such a design of the combustion chamber is cumbersome.

It is an object of the present invention to specify a combustion chamber of the type mentioned in the introduction, and a gas turbine having a combustion chamber of said type and a method, by means of which combustion chamber the suppression of combustion chamber pressure oscillations is made possible and which combustion chamber has a particularly simple construction and thus low production costs.

The object is achieved according to the invention, in the case of a combustion chamber of the type mentioned in the introduction, in that the combustion chamber comprises at least one interference body, which can be impinged on by flow and which can be assigned a Strouhal number, for generating fluidically induced sound waves, wherein the interference body is arranged in a passage which issues into the combustion zone, which passage can be traversed by a flow of a fluid flowing in the direction of the combustion zone, and by means of an impingement of flow on the interference body, a sound wave can be generated which has a frequency which substantially corresponds to the frequency of a combustion chamber pressure oscillation to be suppressed.

Combustion chamber pressure oscillations to be suppressed form in the combustion chamber during the operation of the gas turbine and are predefined by the gas turbine. That is to say that any gas turbine, during operation within power ranges, tends to exhibit the formation of combustion chamber pressure oscillations of very specific frequencies. For example, a specific gas turbine may always form the frequencies 5-7 Hz, 220 Hz and 270 Hz at a low gas turbine power output, and may then only form the frequencies 90 Hz, 115 Hz, 170 Hz, 260 Hz and 350 Hz in a higher power range. According to the invention, the interference body is designed, and arranged in the passage, such that, by means of an impingement of flow on the interference body, a sound wave can be generated which has a frequency which substantially corresponds to the frequency of a combustion chamber pressure oscillation to be suppressed. The expression “combustion chamber pressure oscillation to be suppressed” may also be referred to as dominant frequency.

The sound wave generated by means of the interference body is superposed on the combustion chamber pressure oscillation to be suppressed, and may exhibit phasing which leads to an elimination or dissipation of the combustion chamber pressure oscillation. Here, the phasing between the sound wave generated by means of the interference body and the combustion chamber pressure oscillation does not need to correspond exactly to a value but rather may be selected such that a desired suppression of the combustion chamber pressure oscillation is achieved. The phasing of the sound wave may be set for example by means of the length of the passage. It is preferable for the frequency of the sound wave to be selected so as to substantially correspond to a dominant frequency of the combustion chamber. For this purpose, the passage and the interference body inter alia are selected such that the desired frequency of the sound wave is generated. The Strouhal number assigned to the interference body is a dimensionless characteristic number used in the field of fluid mechanics. The Strouhal number is for example the ratio of the product of vortex shedding frequency, a value of the obstruction around which flow passes, and the flow impingement speed of the fluid. A value of the obstruction around which flow passes may for example be a length of a passage section from an air inlet to the interference body. The shape of the interference body and the length of the passage may in this case be selected so as to yield a Strouhal number which is such that, for a given flow impingement speed of the fluid flowing in the passage, a vortex shedding frequency is set which corresponds to the desired frequency of the dominant combustion chamber pressure oscillation to be suppressed. With a corresponding intensity of the flow in the passage, effective suppression of the combustion chamber pressure oscillation can be achieved with just a single interference body according to the present invention. An arrangement of a multiplicity of resonators on the housing of the combustion chamber, as per the prior art, can be dispensed with. The combustion chamber according to the invention thus has a particularly simple construction, whereby production costs can be lowered.

Advantageous refinements of the invention are specified in the following description and in the subclaims.

In one advantageous refinement of the invention, it may be provided that, between the Strouhal number Str assigned to the interference body, a sound wave of frequency f that can be generated by the impingement of flow on the interference body, a flow speed v of the fluid flowing in the passage and a length a, substantially the following relationship applies:

Str=f*a/v.

Said relationship may be obtained for example in the case of a cylindrical interference body which is impinged on by flow transversely with respect to its axis of rotation, wherein the length a corresponds to the diameter of the cylinder.

It may advantageously be provided that the length a is the length of a passage section that extends upstream of the interference body in the flow direction.

In one advantageous refinement of the invention, the passage section extends from an air inlet opening to the interference body.

The passage may for example be of hose-like form, having an air inlet opening at one end side and issuing into the combustion zone at the other end side.

It may also advantageously be provided that the air inlet opening is circular or rectangular.

The air inlet opening and the interference body may be arranged in alignment or so as to be offset. The interference body preferably has a prismatic shape with a triangular base surface. In this case, the tip of the triangle forms an edge, which can be impinged on by flow, in the direction of the air inlet opening.

Alternatively, the size of the obstruction around which flow is to pass may be selected as the length a.

In one advantageous refinement of the invention, the passage is a premixing passage of the burner arrangement.

Since the combustion chamber according to the invention comprises at least one burner arrangement with at least one premixing passage in any case, the suppression of a combustion chamber pressure oscillation can be made possible in a particularly simple and inexpensive manner by arranging the interference body in said premixing passage. The burner arrangement may for example involve a pilot burner and a group of main burner arranged around the pilot burner. One exemplary embodiment of the refinement may provide that the pilot burner and the main burner each comprise a cylindrical burner housing and a lance arranged centrally in said burner housing, which lance is supported on the housing via swirl vanes. The lance is connected to a fuel duct and, at its end pointing toward the combustion zone, has fuel nozzles for the injection of fuel into the cylindrical burner housing. The cylindrical burner housing is traversed by a flow of compressed air, with swirl being imparted to said air by the swirl vanes, wherein the fuel that is injected into the air flow is mixed with the air flow in the cylindrical burner housing and exits the housing, in the direction of the combustion zone, in the form of a fuel/air mixture. Within the context of this invention, a burner housing of said type may for example be referred to as a premixing passage of the burner arrangement. In the refinement of the invention, an interference body may be arranged in at least one of the burner housings in order to generate sound waves.

It may also be considered to be advantageous that the combustion chamber has at least one second axial stage, such that the combustion zone is divided into at least one first and one second combustion zone, and the second combustion zone is arranged downstream of the first combustion zone in a main flow direction, a first burner arrangement is designed for the combustion of a first working gas stream to be ignited in the first combustion zone, a second burner arrangement is designed for the combustion of a second working gas stream to be ignited in the second combustion zone, and the passage is a premixing passage comprised by the second burner arrangement.

It is normal for the burner arrangement of the second axial stage to be arranged around the housing of the combustion chamber and to comprise introduction passages which issue into the interior of the housing. A fuel/air mixture is conducted into the interior of the housing, into the second combustion zone, via the introduction passages. Said introduction passages can be adapted in length in a simple manner, such that it is particularly advantageous for an interference body according to the invention to be arranged in at least one of said introduction passages.

In one advantageous refinement of the invention, the interference body may have substantially the shape of a straight prism with a triangular base surface. An interference body of this shape is particularly easy to produce.

It is a further object of the invention to specify a gas turbine having a combustion chamber of the type mentioned in the introduction, which gas turbine has a particularly simple construction and thus low production costs.

According to the invention, the object is achieved, in the case of a gas turbine of the type mentioned in the introduction, in that the combustion chamber is designed as claimed in at least one of claims 1 to 8.

It is a further object of the invention to specify a method for suppressing combustion chamber pressure oscillations, which method can be realized with a particularly simple construction and thus low production costs.

According to the invention, the object is achieved, in the case of a method of the type mentioned in the introduction, in that at least one sound wave is generated which has a frequency which substantially corresponds to the frequency of a combustion chamber pressure oscillation to be suppressed, the sound wave is superposed, in antiphase, on the combustion chamber pressure oscillation to be suppressed, wherein the sound wave is generated by the impingement of flow on at least one interference body by virtue of a ratio between a Strouhal number STR of the interference body, a flow impingement speed v of a fluid impinging on the interference body, and a length a being selected in accordance with the frequency f to be generated.

Here, the ratio may advantageously be defined by the equation STR=f*a/v.

One advantageous refinement of the invention may provide that the length of a passage section extending upstream of the interference body in the flow direction is selected as the length a.

The size of the obstruction around which flow is to pass may also be selected as the length a.

Further expedient refinements and advantages of the invention will emerge from the description of exemplary embodiments of the invention with reference to the figure of the drawing, wherein the same reference signs are used for components of equivalent effect.

In the drawing:

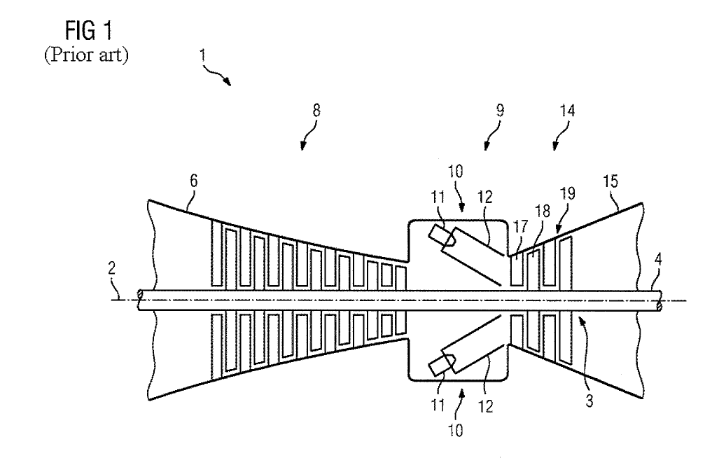

FIG. 1 shows a schematic sectional view of a gas turbine according to the prior art,

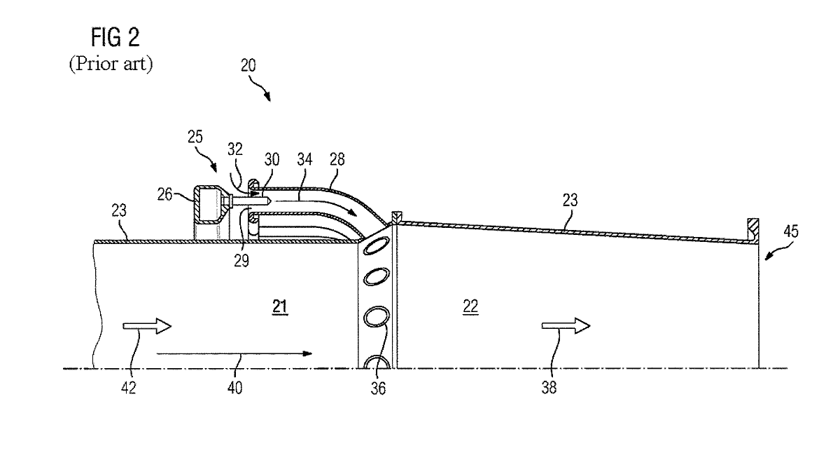

FIG. 2 shows, in a schematic sectional view, a detail of a combustion chamber with a second axial stage according to the prior art,

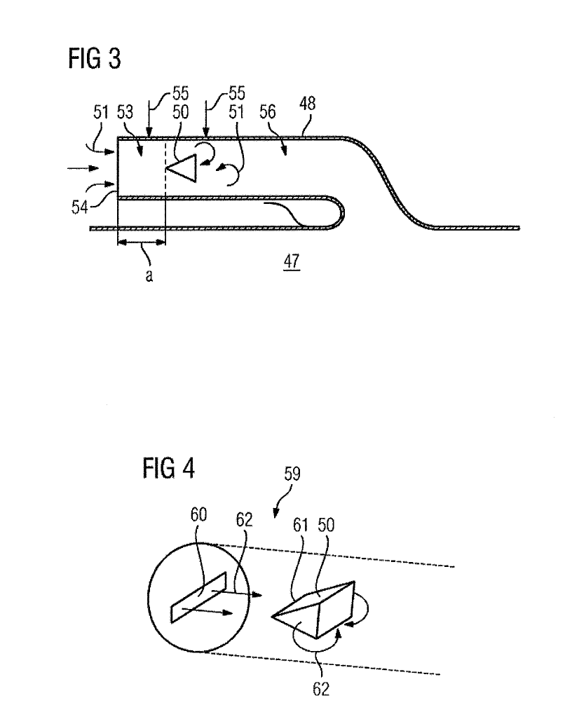

FIG. 3 shows a schematic detail view of a combustion chamber according to the invention according to a first exemplary embodiment, in the region of a passage with interference body, and

FIG. 4 shows, in a perspective view and schematic illustration, an air inlet region of a passage according to the invention with interference body according to a second exemplary embodiment.

FIG. 1 shows a schematic sectional view of a gas turbine 1 according to the prior art. The gas turbine 1 has, in the interior, a rotor 3 which is mounted so as to be rotatable about an axis of rotation 2 and which has a shaft 4, said rotor also being referred to as turbine rotor. Arranged in succession along the rotor 3 are an intake housing 6, a compressor 8, a combustion system 9, a turbine 14, and an exhaust housing 15, the combustion system 9 having a number of combustion chambers 10 which each comprise a burner arrangement 11 and a housing 12.

The combustion system 9 communicates with a hot-gas duct, which is for example of annular form. There, multiple turbine stages positioned one behind the other form the turbine 14. Each turbine stage is formed from rings of blades. In the hot-gas duct, as viewed in the flow direction of a working medium, a row formed from guide blades 17 is followed by a row formed from rotor blades 18. Here, the guide blades 17 are fastened to an inner housing of a stator 19, whereas the rotor blades 18 of a row are for example attached via a turbine disk to the rotor 3. A generator (not illustrated), for example, is coupled to the rotor 3.

During the operation of the gas turbine, air is drawn in through the intake housing 6, and compressed, by the compressor 8. The compressed air that is provided at the turbine-side end of the compressor 8 is conducted to the combustion system 9 and, in the latter, is mixed with a fuel in the region of the burner arrangement 11. Then, with the aid of the burner arrangement 11, the mixture is burned so as to form a working gas stream in the combustion system 9. From there, the working gas stream flows along the hot-gas duct past the guide blades 17 and the rotor blades 18. The working gas stream expands at the rotor blades 18 so as to impart an impetus thereto, such that the rotor blades 18 drive the rotor 3, and said rotor drives the generator (not illustrated) that is coupled thereto.

FIG. 2 shows, in a schematic sectional view, a detail of a combustion chamber 20 with a second axial stage according to the prior art. The combustion chamber 20 comprises a first combustion zone 21 and a second combustion zone 22, with a housing 23 surrounding the combustion zones, and comprises a first burner arrangement (not illustrated) and a second burner arrangement 25. The second burner arrangement 25 comprises an encircling fuel distributor ring 26, which is arranged outside the housing 23, and a multiplicity of premixing passages 28 which are arranged around the housing and which issue into the second combustion zone 22. The premixing passages 28 are of hose-like form, wherein fuel nozzles 30 that branch off from the fuel distributor ring 26 project into an air inlet opening 29 of the premixing passages 28. Fuel injected from the fuel nozzles 30 is admixed to an air flow 32 flowing into the premixing passage 28, such that the fuel/air mixture flows along a flow direction 34 to an outlet 36 of the premixing passage 28 and enters the second combustion zone 22 and, after the ignition of the mixture, forms a second working gas stream 38. If pressure fluctuations occur in the combustion zones 22, 21, fluctuations in concentration of the fuel/air mixture occur in the at least one premixing passage 28, which fluctuations in concentration lead to fluctuations in the release of heat during the combustion. These thermoacoustic instabilities form disruptive combustion chamber pressure oscillations, wherein dominant frequencies for said combustion chamber pressure oscillations exist in the combustion chamber 20. Said combustion chamber pressure fluctuations occur both in the case of combustion chambers with only one axial stage (see FIG. 1, reference sign 10) and also in the case of combustion chambers 20 with a second axial stage. The second axial stage of a combustion chamber of said type serves for the reduction of pollutant emissions. Here, a first hot working gas stream 42 flowing in a main flow direction 40, which first hot working gas stream has been ignited by means of the first burner arrangement (not illustrated) in the first combustion zone 21, is mixed in the second combustion zone 22 with the second working gas stream 38, and forms a common turbine inlet profile together therewith at a combustion chamber outlet 45.

FIG. 3 shows a passage 48, which issues into a combustion zone 47 of a gas turbine combustion chamber, and which has arranged in the passage 48 an interference body 50 according to one exemplary embodiment of the invention. The interference body 50 can be assigned a Strouhal number, wherein in the exemplary embodiment illustrated, said interference body has the shape of a prism with a triangular base surface. The passage 48 is traversed by a fluid 51 flowing in the direction of the combustion zone 47, wherein the fluid 51 has a flow speed v and impinges on the interference body 50. Here, in the fluid 51, vortices are generated with a vortex shedding frequency f. The impingement of flow on the interference body 50 accordingly makes it possible for a sound wave with a frequency f to be generated in the fluid 51 flowing to the combustion zone 47, which sound wave can be superposed on a combustion chamber pressure oscillation that is to be suppressed in the combustion zone 47. In order that the frequency f of the sound wave generated substantially corresponds to the frequency of the combustion chamber pressure oscillation to be suppressed, it is for example possible for the ratio between the Strouhal number STR of the interference body 50, a length a and the flow speed v of the fluid 51 to be selected in accordance with the formula

STR=f*a/v,

which is known from the field of fluid mechanics. It is for example possible for the length of a passage section 53 that extends upstream of the interference body 50 in the flow direction to be selected as the length a. In the exemplary embodiment illustrated, said passage section extends from the air inlet opening 54 to the interference body 50. The passage 48 may be a premixing passage of the combustion chamber. In this case, the fluid 51 is an air stream into which fuel 55 is injected at the locations indicated by way of example. The premixing passage may for example be encompassed by a second burner arrangement of the second axial stage. The relative phasing of the generated sound wave and the combustion chamber pressure oscillation can be set for example by means of a length of a passage section downstream of the interference body 50—for example by means of the length of a passage section 56 that extends from the interference body 50 to the outlet to the combustion zone. Here, the phasing is set so as to realize a desired suppression of the combustion chamber pressure oscillation.

FIG. 4 shows an air inlet region of a passage 59 according to the invention, with an interference body 50 arranged in the passage 59. A rectangular air inlet opening 60 is situated upstream of the interference body 50, which has the shape of a prism with a triangular base surface. The air inlet opening 60 and the interference body 50 are arranged in alignment with one another, wherein the tip of the triangle forms an edge 61, which can be impinged on by flow, in the direction of the air inlet opening 60. A fluid 62 flowing through the air inlet opening impinges on the interference body 50, which can be assigned a Strouhal number, wherein a sound wave with a frequency f is generated downstream of the interference body 50 in the flow direction as a result of vortex shedding.

1. A combustion chamber for a gas turbine, the gas turbine comprising:
a housing;
a combustion zone which is surrounded by the housing;
at least one burner arrangement comprising at least one premixing passage which issues into the combustion zone and which is configured for providing a fuel/air mixture;
and at least one interference body located and configured to be impinged on by flow through the passage and the body is assigned a Strouhal number, wherein the Strouhal number of the interference body is selected for generating fluidically induced sound waves;
wherein the interference body is arranged in the passage which issues into the combustion zone, wherein the passage is configured to be traversed by a flow of a fluid flowing in the direction of the combustion zone;
the passage and the interference body are configured such that an impingement of the flow in the passage on the interference body generates a sound wave which has a frequency f which substantially corresponds to a dominant frequency of the combustion chamber.

2. The combustion chamber for a gas turbine as claimed in claim 1, further comprising:
substantially the following relationship applies between the Strouhal number Str assigned to the interference body, a sound wave of frequency f that can be generated by the impingement of flow on the interference body, a flow speed v of the fluid flowing in the passage and a length a,
Str=f*a/v

3. The combustion chamber for a gas turbine as claimed in claim 2, wherein the length a is the length of a passage section that extends upstream of the interference body in the flow direction.

4. The combustion chamber for a gas turbine as claimed in claim 3, wherein the passage section extends from an air inlet opening to the interference body.

5. The combustion chamber for a gas turbine as claimed in claim 4, wherein the air inlet opening is circular or rectangular.

6. The combustion chamber for a gas turbine as claimed in claim 1, wherein the passage is a premixing passage of the burner arrangement.

7. The combustion chamber for a gas turbine as claimed in claim 6, further comprising:
the combustion chamber has at least one second axial stage, such that the combustion zone is divided into at least one first and one second combustion zone, and the second combustion zone is arranged downstream of the first combustion zone in a main flow direction;
a first burner arrangement is located and configured for combustion of a first working gas stream to be ignited in the first combustion zone;
a second burner arrangement is located and configured for combustion of a second working gas stream to be ignited in the second combustion zone;
and the second burner arrangement includes the premixing passage.

8. The combustion chamber for a gas turbine as claimed in claim 1, wherein the interference body has substantially the shape of a straight prism with a triangular base surface.

9. A gas turbine having a combustion chamber, wherein the combustion chamber is claimed in claim 1.

10. A method for suppressing combustion chamber pressure oscillations comprising:
generating at least one sound wave which has a frequency f which substantially corresponds to the frequency of a dominant frequency of the combustion chamber;
superposing the sound wave, in antiphase, on a combustion chamber pressure fluctuation with the dominant frequency; and
generating the sound wave by impingement of a flow on at least one interference body, wherein a ratio between a Strouhal number STR of the interference body, a flow impingement speed v of a fluid impinging on the interference body, and a length selected in accordance with the frequency f to be generated.

11. The method as claimed in claim 10, wherein the ratio is defined by the equation STR=f*a/v.

12. The method as claimed in claim 10, wherein the length a is the length of a passage section that extends upstream of the interference body in the flow direction.
